(19) United States
(12) Patent Application Publication
(10) Pub. No.: US 2008/0235871 A1
(43) Pub. Date: Oct. 2, 2008

(54) Mattress mover

(76) Inventor: Floyd Lawrence York, Arroyo Grande, CA (US)

Correspondence Address: FLOYD LAWRENCE YORK, 950 HAUSNA ROAD #56, ARROYO GRANDE, CA, 93420, US

(21) Appl. No.: 12/005,029

(22) Filed: Dec. 26, 2007

Related U.S. Application Data
(60) Provisional application No. 60/880,524, filed on Jan. 16, 2007.

(51) Int. Cl. B60P 1/04

(52) U.S. Cl. 5/510; 280/6.151

(57) ABSTRACT

This invention provides a novel method of aid and protection in the moving of a mattress or box spring of various sized beds about a residence, retail or commercial premise or institution. It also is very helpful for the handling of panel materials such as sheetrock, plywood, hardy-board or other construction materials, at the same time in all cases affording some protection against back injury and follow-on medical claims plus labor saving, as many of the jobs can be done safely by one person.

### BACKGROUND

A queen sized mattress was given to us and I helped deliver it to our carport where it set for four to five days until I, by inspiration, put together the original device to “move the mattress” across the yard, 30″ up a sires of steps, thru doorways, down a hallway, into and adjacent to the end of the bed in the bedroom. The “mattress moving device” worked very well with little effort, that being a big advantage, as the wife and I were 79 and 81 years old at the time.

Six and one half BILLION people means a lot of BED'S. This piece of equipment is of utilitarian industrial use for targeted markets such as hotels, motels etc., equipment rentals, household mover's, mattress outlet stores and construction projects where paneling or other awkward loads are to be moved around. To meet these few industries needs will require hundreds of thousands of units. This does not address the consumer market other than via equipment rental business outlets.

### PREAMBLE

This invention is designed and constructed to provide a new method of handling awkward rectangular shaped objects to be moved.

It consist of a cart-like vehicular structure consisting of a channel shaped elongated main load bearing floor, mounted on wheels or casters or attached to a, slightly modified, typical floor dolly.

The load bearing floor has four vertical appendages or “wicket shaped-side rails”, one at the front and one at back of each side of the floor. Two of these side rails, on one side, are each fitted with a tie down strap and are to be used on opposite ends of the vehicle.

The wickets with the tie down straps are to be fitted and latched into sockets welded directly to one side of the channel shaped elongated load bearing floor, at diverging angles of 15 degrees. The opposite side is similar in having four sockets for inserting and latching the remaining “wicket shaped” side rails. However these sockets are affixed to an elongated tubular shaped “hinge pin” so as to allow the hinged side to be lowered for ease of loading or unloading. The “hinge” assembly consists of a full vehicle length hinge pin. There are two reinforcing plates, located a short space from either end that are welded directly to the out side of the channel shaped elongated load bearing floor member.

The full length hinge pin is of tubular shape having an inside diameter just large enough to receive the ends of the wicket ends. The “hinge barrel” or knuckle is made up of two “?” shaped clamping brackets that are attached to the two reinforcing plates by bolts, thus holding the “hinge pin” in proper alignment to the vehicle. The ends of the hinge pin are fitted with upturned sockets that are welded at diverging angles of 15 degrees. There are two more sockets fitted and affixed to the top of the “hinge pin” that complete the four sockets needed to receive the ends of the remaining “wickets”. There is a pair of roll pins that are fitted thru the “hinge pin” just inward of the inside edges of the barrel brackets. The pins extend a short length through the outside diameter of the “hinge pin” on either end in order to provide restraint of longitudinal travel of the “hinge-pin” assembly. The whole assembly can be partially disassembled, packed and strapped together for suitcase like compactness and ease of transporting when not supporting a mattress.

### SUMMARY OF INVENTION

The vehicle provides an agile, convenient method of moving a bed that constrains and affords a measure of protection for said mattresses and walls and door casings while being moved from room to room or to or from a waiting moving van etc.

### DESCRIPTION of DRAWINGS

FIG. 1 is a perspective view showing the preferred embodiment of the invention mounted to a typical floor dolly, slightly modified, shown in dotted line and having a mattress loaded and secured by tie down straps, the mattress being shown by phantom line.

FIG. 2 is a perspective view showing the unique means of one side rail assembly being hinged and laying down to the floor to aid in loading or unloading. A mattress is indicated by phantom line and an attached floor dolly is shown by dotted line.

FIG. 3 is a perspective view showing a disassembled unit bundled up like a suitcase for compactness, portaging or storage.

FIG. 4 is a perspective view showing a three wheeled variation with wheels permanently attached, and showing extender plates for foam mattress support. A loaded mattress is indicated by phantom line.

FIG. 5 is a cross section taken along section line A-A of FIG. 4 and showing the hinge mounting arrangement.

FIG. 6 is an enlarged side view of the “hinge” assembly showing, in break-away, the roll pins that restrain longitudinal movement of the hinge pin.

FIG. 7 is a cross sectional view taken along section line D-D of FIG. 2 and section line C-C showing how the assemblage is fastened to a modified floor dolly.

FIG. 8 is an exploded perspective view of a fastening of a floor dolly that is modified to receive a DUZE fastener assembly that is used to readily fasten or unfasten the invention to or from the dolly by a Duze quick fastener assembly and the foam mattress adaptor plate interaction with floor.

FIG. 9 is a cross sectional view taken along section line B-B of FIG. 1 and shows a typical connecting arrangement for a stanchion leg into a socket.

FIG. 10 is a cross section taken along section line C-C of FIG. 4 showing how the foam mattress adaptor connects to the floor of the main frame.

FIG. 11 is a perspective view of an extender plate.

### DESCRIPTION of PREFERRED EMBODIMENT

FIG. 1 shows the preferred cart 10, mounted by two Duze “quick fastener” assemblies, 15 one towards either end of floor 11 to a modified floor dolly 20, shown by dotted line. The elongated main load bearing floor 11 has four sockets 12 affixed to one side rail 16 and four sockets 13 affixed to a hinge pin 14 that is pivotally mounted to the opposite side rail 17 of the cart 10.

There are four near identical wicket shaped stanchions 21 that have bottom ends 22 that fit into sockets 12 or 13 and lock into place by typical locking means 23 shown in FIG. 9. The outboard end 22 of each stanchion 21 is shortened by approximately 2½″ to facilitate the 15 degree angle of tilt outward.

All of the stanchions 21 mount a hand grip 44 near the top longitudinal extremity of the cart assembly. The handgrips 44 afford a measure of protection from marking walls, doors or door casings. Two of the four near identical stanchions have a tie down strap 40 and a bundling tab 41 affixed to the upper and outer ends. These two stanchion strap sub assemblies are preferably to be used in conjunction with the non-hinged sockets 12 of side rail 16.

The straps 40 are used to secure the load L as indicated by phantom line. The bundling tabs 41 are approximately 12″ long and incorporate a Velcro arrangement for tidying up the tie down straps 40 when not in use as indicated in FIG. 2.

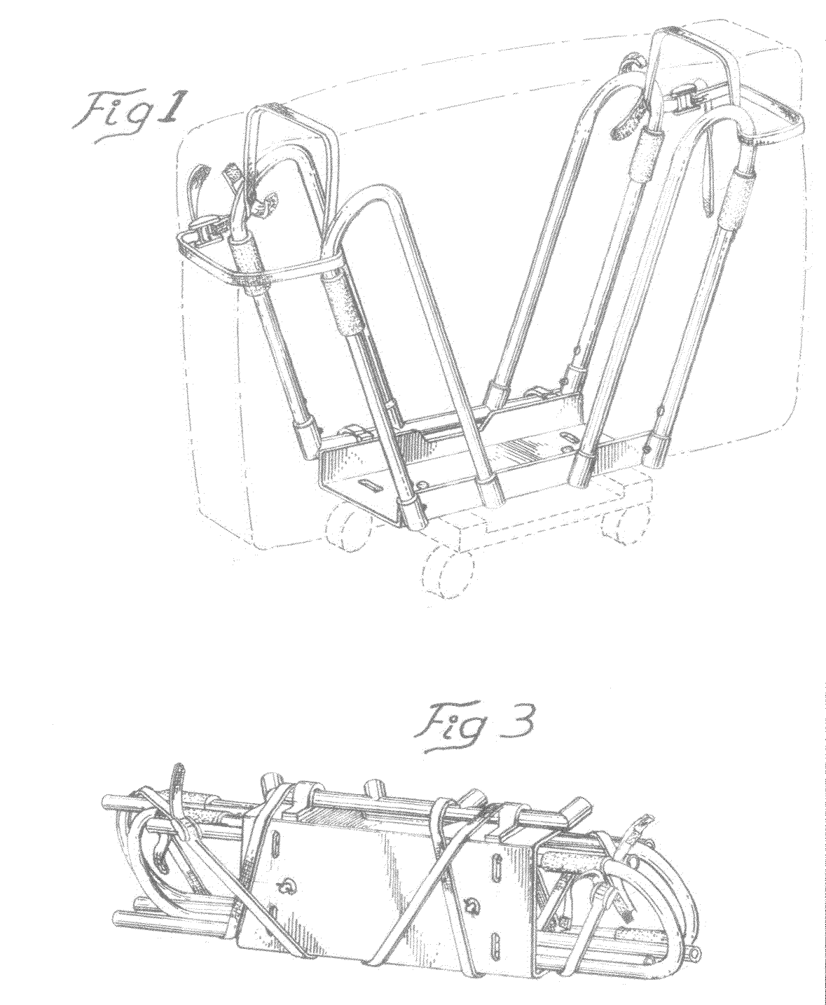

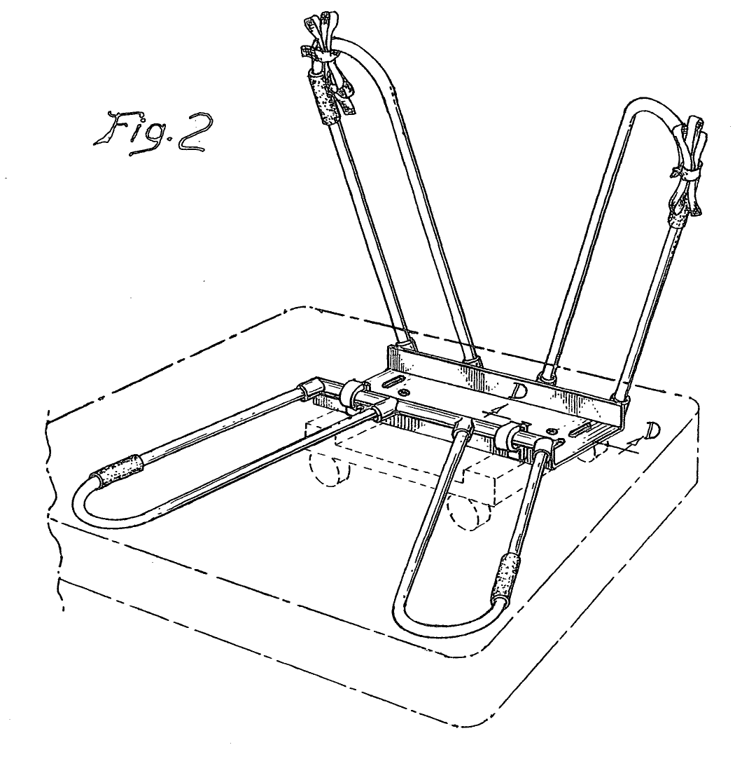

The tie down straps 40 are also employed to secure all of the stanchions 21 into the channel shaped, main load bearing floor 11, forming a suitcase shaped configuration shown in FIG. 3 that facilitates handling and storage when not in use.

There are two slots 45 at either end, best shown in FIG. 3, that penetrate the floor 11. Two are located to wards either end running crossways in the floor 11. These slots are to accommodate two adaptor plates 50 for foam mattress's, shown in FIG. 4, deployed, in a foam mattress supportive position. FIG. 7 shows the plate 50 having offset tabs 51 on one end that cooperate the slots 45 in the floor 11. When not deployed the plates 50 can be reversed and laid inward on the inside of floor 11, overlapping one over the other when not in use. The extended shown in FIG. 7 shows tab 51 interacting with slot 45 in the floor 11. The outboard ends of plates 50 are slightly tipped up.

FIG. 7 also illustrates a Duze fastener 15 in section view taken along D-D of FIG. 2. The Duze fastener is more clearly illustrated in FIG. 8, an exploded view that shows the relationship with a dolly 20 and bracket 26 that is modified to accommodate the Duze socket sub assembly 32.

FIG. 5 shows a cross section view taken along A-A of FIG. 4 showing the side wall 17 mounting a reinforcing plate 16 that provides a foundation area on wall 17 so as to mount the hinge knuckle 15 to the main frame 10 via fasteners 18. The “?” shaped hinge knuckle 15 is so shaped as to apply some friction on the hinge pin 14 so as to keep the side rail assembly 25 in place wherever positioned.

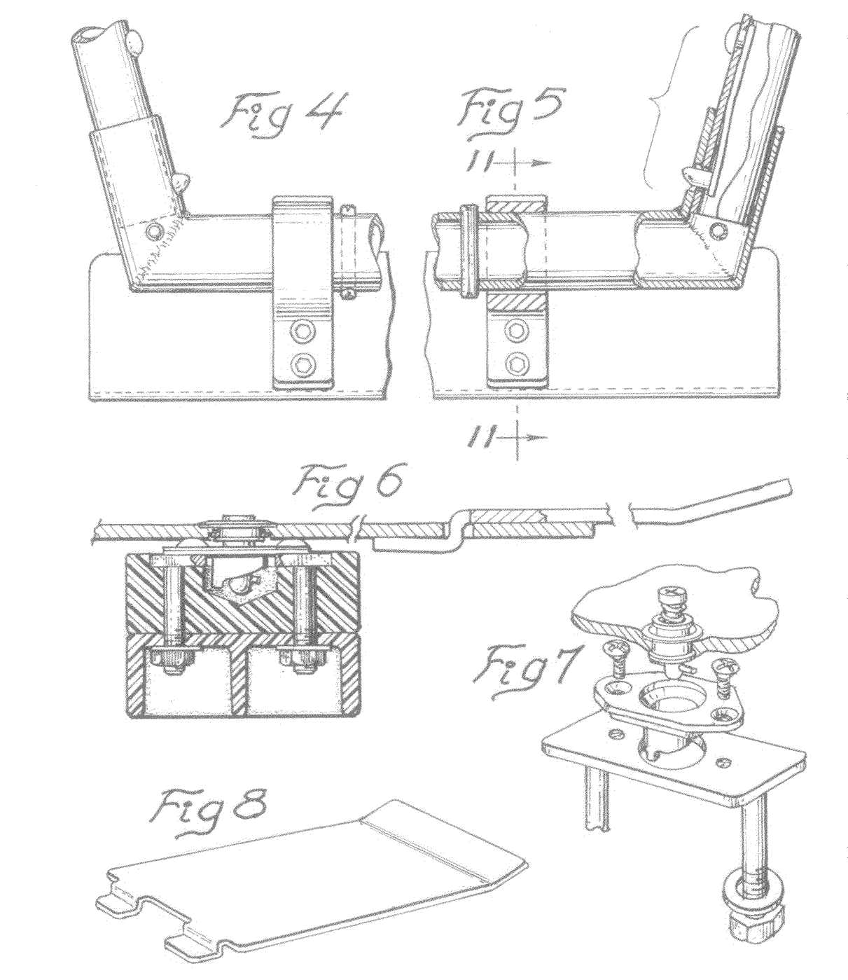

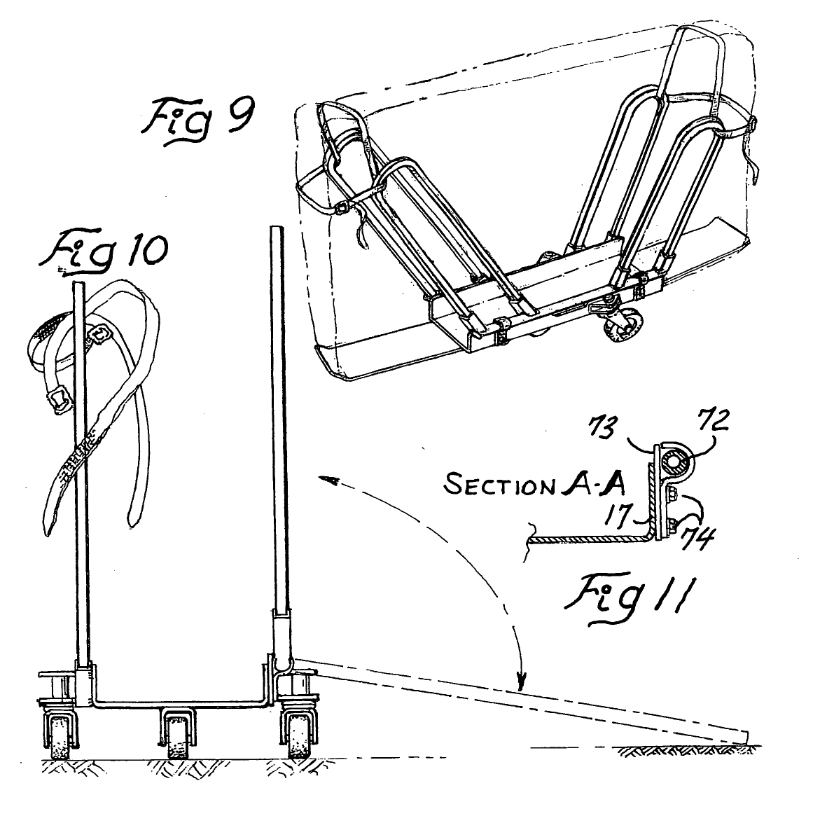

FIG. 6 is a side view of the hinged side rail assembly 25 in elevation with the areas in section that reveal the roll pins 19 that are positioned in hinge pin 15 so as to limit longitudinal movement. One of the sockets 13, and stanchion 21 arrangements are also shown in section to illustrate stanchion mounted locking means 60 and roll pin 56 that is only used on the outboard sockets 13 to limit the depth of penetration of stanchion end 22. The locking means 60 resembles a typical vacuum hose connection.

What is claimed as being new and desired to be protected by Letters Patent of the United States is as follows:

1. I claim a unique cart like device to aid in the awkward chore of moving a mattress that will lessen the ‘man-power’ requirement and lessen the risk of muscular strain of people tasked with such a job.

2. I claim a cart like device that has four stanchions that are croquet wicket or hoop shaped, two along either side, that form side rails for constraining a mattress, one side pair fitting into sockets affixed to one elongated side of the cart frame and the other pair fitting into sockets that are affixed to an elongated cylindrical ‘hinge pin’ member, attached to the opposite side of the cart frame in a pivotable manner that provides a desired hinging effect of said stanchions, said hinging effect to enhance the loading and unloading of the cart.

3. I claim a cart like device that has four stanchions, two along either side, that form side rails for constraining a mattress, having the four bottom ends of one side pair fitting into sockets affixed to the elongated side of the cart frame and the other stanchion pair ends fitting in like manner into sockets that are affixed to the elongated cylindrical member, that is attached to the opposite side of the cart frame in a pivotable manner providing a desired hinging effect, said hinging effect to enhance the loading and unloading of the cart, and said hinge effect being designed to dampen movement, by a friction means incorporated into the adjustable ‘hinge barrel’ clamp assemblies that secure the ‘hinge side’ rail to the cart frame, providing control of the raising or lowering of the ‘hinge side’.

4. I claim a cart like device that has four stanchions, two along either side, that form side rails for constraining a mattress, one side pair fitting into sockets affixed to one elongated side of the cart frame, said ‘rigidly’ mounted stanchions only, having tie down and bundling straps attached to their respective upper end areas, said tie down and bundling straps provide means for securing the load for transit and aiding in the raising or lowering of a mattress for loading or off loading said mattress.

5. I claim a cart like device that has four stanchions, two along either side, that form side rails for constraining a mattress. All four stanchions are identical in size and shape, save for the tie-down and bundling straps affixed to two only of the four stanchions. A typical stanchion is of an exaggerated croquet ‘hoop or wicket shape’ with about a 12″ diameter by 180 degree bend just off the center of a 10 foot length of tubing causing one leg to be short of the other. Thus, with the short leg positioned outboard causing about a 15 degree cant diverging outward along the long axis of the cart thus providing a greater area of support for the mattress's.

6. I claim a cart like device to aid in the awkward chore of moving a mattress that will lessen the ‘man-power’ requirement and risk of muscular strain of people tasked with such a job. Said device to have a combination of wheels so as to enhance maneuverability in confined or restricted spaces and will include at least two selectively lockable caster wheels and two axial aligned wheels so as to track in a longitudinally steerable path. Said wheel arrangements to be mounted somewhat inboard of either end of cart, providing a short wheelbase, affording stability and maneuverability.

7. I claim the auxiliary use of either of the cargo tie down straps having a uniquely configured hook and loop fastening means for readily connecting or disconnecting to facilitate the raising and lowering of a mattress laden hinge side pair of stanchions of the mattress mover cart like device.

8. I claim a uniquely designed combination of cooperating components consisting of a channel shaped main frame or chasse component, plus or minus four foot long by plus or minus one foot wide with upturned sides approximately three inches high, one elongated outside having four stanchion mounting sockets permanently affixed and the opposite elongated outside having a full chasse length tubular member or ‘hinge pin’ of about one and one quarter inch in diameter having four stanchion mounting sockets permanently affixed, being pivotable mounted by two brackets, being ‘question mark’ shaped which act as a ‘hinge barrel’. Said hinge barrel provides an adjustable mounting means to the chasse for varying the friction of the formed ‘hinge knuckle’ to control ‘free fall’ of stanchions when lowering or raising for loading or unloading. The ‘hinge barrel bracket forms two angular shaped cavities where they join against the chasse which either one is used as an indexing notch for a spring loaded ball detent component that is mounted into the hinge pin at such an angle and longitudinal location as to hold the ‘hinged stanchion side in a vertical position while a load is being secured the above mentioned stanchion sockets are mounted towards either end of the chasse or hinge pin in pairs about one foot apart and at a diverging angle of approximately 15 degrees allowing the hoop shaped stanchions to be inserted or removed as desired. Two of the four hoop shaped stanchions have tie down and bundling straps attached and are only used on the none hinged side of the chasse. Either tie down strap is also used as an aid to raise or lower a load. Said straps have unique ‘open loop’ end with hook and loop fastening material to provide convenient attaching to a stanchion top for lifting or lowering a load. This assemblage has wheels mounted to the chasse or is selectively attached to a floor dolly to afford extreme maneuverability to the resulting monolithic cart like device to aid in the awkward chore of moving a mattress that will lessen the ‘man-power’ requirement and lessen the risk of muscular strain of people tasked with such a job.
